(19) United States
(12) Patent Application Publication
(10) Pub. No.: US 2003/0056556 A1
(43) Pub. Date: Mar. 27, 2003

(54) Lever door lock device

(76) Inventors: Dea San Park, Daegu (KR); Joo Seok Jeong, Daegu (KR)

Correspondence Address: JONATHAN Y. KANG, ESQ., LEE & HONG P.C., 11th Floor, 221 N. Figueroa Street, Los Angeles, CA, 90012, US

(21) Appl. No.: 10/247,006

(22) Filed: Sep. 19, 2002

(30) Foreign Application Priority Data
Sep. 21, 2001 (KR) 2001-2919-9

(51) Int. Cl. E05B 13/10

(52) U.S. Cl. 70/224

(57) ABSTRACT

Disclosed is a lever door lock device that has an outside part including a lever, a key cylinder block, a cover, and a spindle, disposed at one side of a retractor, and an inside part including a lever, a cover and a locking unit, disposed at the other side of the retractor, the lever door lock device including: an adjusting screw pipe coupled to one end of the spindle and to the cover; an outside part operation unit having an operation ring, a stop ring, a torsion spring, a small spindle, a fixing frame and an outer spindle support between the outside part and the retractor; and an inside part operation unit for coupling an inner spindle, a large housing, a stop ring, a torsion spring, an operation ring and a small spindle, between the outside part and the retractor.

### BACKGROUND OF THE INVENTION

1. Field of the Invention

The present invention relates to a door lock device, and more particularly, to a lever door lock device that is provided with improved principal assembling structures of a lever, thereby ensuring high assembling performance and durability.

2. Background of the Related Art

Generally, door lock devices are classified into tubular type ones for simply opening and closing a door and cylinder type ones having a function of more safely locking a door. Recently, the cylinder type door lock devices are structured in a more complicated manner and have diverse functions including the prevention of a dropping phenomenon of a lever, such that are used in most of doors, which need more safety.

By the way, the cylinder type door lock devices are coupled internally and externally in a relatively complicated manner, so that it is not easy for even an expert who knows well the structure of them to assemble them. This causes the manufacturing productivity to be considerably lowered and further makes a user difficult to install a finished door lock or change a used door lock to a new one.

Besides, the cylinder type locking devices are provided with a housing thereon, the housing molded in a two-stage cylindrical structure to accommodate principal parts, so that it is difficult to assemble them. Additionally, there is generated a metal friction between a cover and inside and outside levers upon their operation, which aggravates undesirable noises or wearing.

### SUMMARY OF THE INVENTION

Accordingly, the present invention is directed to a lever door lock device that substantially obviates one or more problems due to limitations and disadvantages of the related art.

An object of the present invention is to provide a lever door lock device that is provided with improved principal assembling structures of a lever, thereby ensuring high assembling performance and durability.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To accomplish this and other objects of the present invention, there is provided a lever door lock device that has an outside part including a lever, a key cylinder block, a cover, and a spindle, which are disposed at one side of a retractor, and an inside part including a lever, a cover and a locking unit, which are disposed at the other side of the retractor, the lever door lock device including: an outside part lever having a key cylinder adapted to receive the spindle having a cut groove formed thereon and the key cylinder block located on the rear end of the spindle with the key cylinder block being fitted into the spindle, for opening and closing a door upon the operation of the outside part lever; an adjusting screw pipe coupled to one end of the spindle and simultaneously to the cover; an outside part operation unit having an operation ring, a stop ring, a torsion spring, a small spindle, a fixing frame and an outer spindle support, which are coupled to one another between the outside part and the retractor, for transmitting the operational force of the outside part lever to the retractor; an inside part lever having a key cylinder adapted to receive a spindle having a cut groove formed thereon and a locking unit located on the rear end of the spindle with the locking unit being fitted into the spindle, for opening and closing the door upon the operation of the inside part lever; and an inside part operation unit for coupling an inner spindle, a large housing, a stop ring, a torsion spring, an operation ring and a small spindle, which are coupled to one another between the outside part and the retractor, for transmitting the operational force of the inside part lever to the retractor.

The adjusting screw pipe is provided with a metal piece that is fittedly mounted on the cut portion formed at one side thereof, and the small housing is also provided with such the metal piece thereon. The retractor has a saddle and a general spring which are inserted and installed thereinto, and disposed at the portion where the lever and the cover come in contact with each other is provided with a generally annular ring that has a generally ‘ [symbol] ’-shaped section.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view illustrating a lever door lock device according to the present invention;

FIG. 2 is an enlarged perspective view of an adjusting screw pipe of the present invention; and

FIG. 3 is a sectional view illustrating a lever door lock device according to the present invention in which the outside part thereof is assembled.

### DETAILED DESCRIPTION OF THE PREFERRED EMBODIMENT

Reference will now be made in detail to the preferred embodiments of the present invention, examples of which are illustrated in the accompanying drawings.

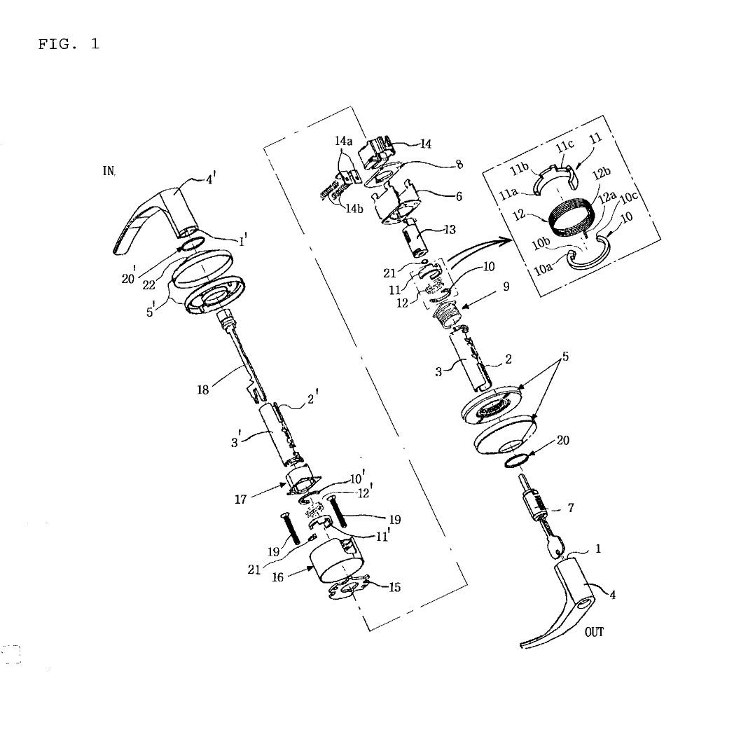

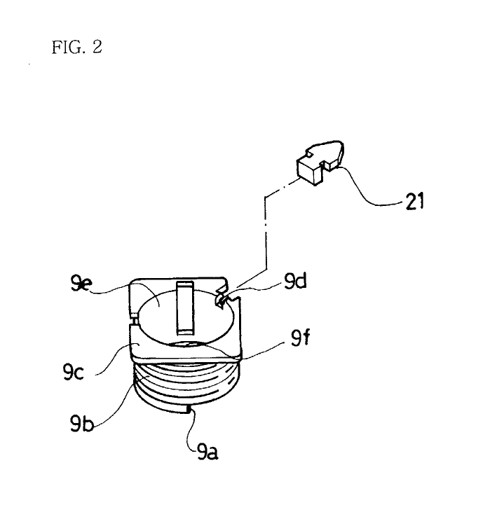

FIG. 1 is an exploded perspective view illustrating a lever door lock device according to the present invention, and FIG. 2 is an enlarged perspective view of an adjusting screw pipe of the present invention.

Referring to FIGS. 1 and 2, there is shown a cylinder type lever door lock device that has an outside part including a lever 4, a key cylinder block 7, a cover 5, and a spindle 3, disposed at one side of a retractor and an inside part including a lever 4′, a cover 5′, a locking unit 18, disposed at the other side of the retractor 14. The cylinder type lever door lock device is designed in such a manner that the outside and inside parts thereof operate by engaging with a doorframe and a latch unit keeping locking and unlocking states operates to engage with the retractor 14. The retractor 14 is fixed by using a spring 14b and a saddle 14a. According to the present invention, an outside part operation unit of the cylinder type lever door lock device is assembled on the right side of the retractor 14 and an inside part operation unit thereof is on the left side thereof.

The outside part operation unit includes an operation ring 10, a stop ring 11, a torsion spring 12, a small spindle 13, a fixing frame 6, and an outer spindle support 8 and is coupled to one another between the outside part and the retractor 14 to transmit the operational force of the lever 4 to the retractor 14. The inside part operation unit includes an inner spindle 15, a large housing 16, a stop ring 11′, a torsion spring 12′, an operation ring 10′, and a small housing 17 and is coupled to one another between the inside part and the retractor 14 to transmit the operational force of a lever 4′ to the retractor 14. The outside part operation unit is provided with the key cylinder block 7 that has a locking function. The spindle 3 into which the key cylinder block 7 is accommodated is coupled at one end to the lever 4 through the cover 5 and at the other end to the fixing frame 6 through the adjusting screw pipe 9 and the small spindle 13. A spindle 3′ in the inside part operation unit is coupled at one end to the locking unit 18 and the cover 5′ and at the other end to the housings 17 and 16 and the inner spindle 15. The inside part operation unit is fastened by means of locking bolts 19 and therefore, the cover 5′ is provided with holes 22 through which the locking bolt 19 passes.

At this time, the adjusting screw pipe 9 has a threaded portion formed thereon and receives the operation ring 10, the stop ring 11 and the torsion spring 12 therein, such that it serves to adjust the coupling position with the cover 5. This is able to cope with all doors having various thicknesses and also to prevent the lever 4 from being drooped. According to the present invention, the small housing 17 does not have a threaded portion thereon, but may have the threaded portion thereon.

According to the present invention, the housings 16 and 17 are formed in a cylinder shape in such a manner as to have different diameters and to be separated from each other. The large housing 16 is a cylinder having a relatively large diameter, and the small housing 17 is a cylinder having a relatively small diameter. The housings 16 and 17 are not necessarily coupled by additional coupling means such as a bolt. But it is advantageous that they are engaged with each other. Like this, when the housings are configured in a separable structure, the assembling of the components at the front and back sides thereof can be done easily. On the other hand, a conventional two-stage integrated structure has a generally deep internal space, which causes the assembling performance to be substantially decreased.

In the meantime, the operation units on the left and right sides of the retractor 14 is not limited to the assembling order as shown in FIG. 1, but some components which have been temporarily pre-assembled may be assembled as an integrated single pieces therein.

According to the present invention, as shown in FIG. 2, the adjusting screw pipe 9 has a cut part at one side of an opening 9a thereof and a metal piece 21 that is fitted into the cut part thereof. The adjusting screw pipe 9 having an opening 9e formed at the front end thereof has a stage protrusion 9f formed at one side of the rear end thereof, a threaded part 9b formed on the outer peripheral surface thereof, fixing flange 9c formed at the front end thereof in such a manner as to be extended outwardly from the front end, and a bent protrusion 9d formed at one side of the front end thereof. The operation ring 10 is provided with an opening lob that has the circumference corresponding to one-fourth of that of the opening 9e of the adjusting screw pipe 9, and a locking lug 10a. The stop ring 11 is in the shape of somewhat larger circle than a general semicircle and is provided with a guide portion 11a, a locking protrusion 11b and a reentrant portion 11c.

At this time, the cut part of the adjusting screw pipe 9 is formed on an edge of one side of the square flange portion thereof and on a part of the upper edge of cylindrical portion thereof. The metal piece 21 does not need to have a substantially high preciseness in size and may be made of synthetic resin materials having a high strength and an excellent resistance to abrasion.

When the metal piece 21 is substituted for the cut part of the adjusting screw pipe 9 receiving the operation ring 10, the stop ring 11 and the torsion spring 12, the assembling processes are easily carried out, without having any difficulties.

In the meanwhile, the structure using the metal piece 21 can be applied to the inside part operation unit using the same principle as that used in the outside part operation unit. That is to say, the small housing 17 of the inside part operation unit is constructed in such a manner as to receive the operation ring 10′, the stop ring 11′ and the torsion spring 12′ and perform the same functions similarly to the adjusting screw pipe 9 under the similar structure thereto. The small housing 17 also has the metal piece 21 mounted on one side thereof, but it is coupled to the cover 5′ and the spindle 3′, while not forming a threaded portion on the outer peripheral surface thereof.

According to the present invention, the lever door lock device may further include a generally annular ring 20 that has a generally ‘ [symbol] ’-shaped cross-section at the portion where the lever 4 and the cover 5 come in contact with each other. A part of the ‘ [symbol] ’-shaped cross-section of the annular ring 20 is accommodated in the contact portion of the lever 4 and the cover 5 and the remaining part thereof is all exposed to the outside of the cover 5. The annular ring 20 may be made of plastic or ceramic materials which have an excellent abrasion resistance. Accordingly, the installation of the annular ring 20 reduces the noises due to a frequent friction rotation between the lever 4 and the cover 5 and further prevents the lever 4 from being loose due to the abrasion according to the friction generated between the lever 4 and the cover 5.

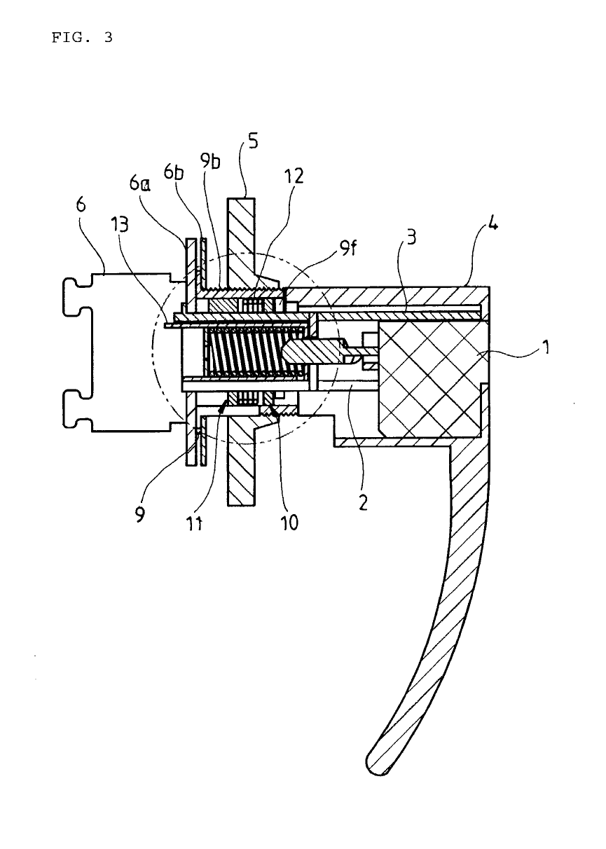

FIG. 3 is a cross-sectional view illustrating a lever door lock device according to the present invention in which the outside part is assembled.

In case of assembling the outside part, the torsion spring 12 is coupled to the operation ring 10 and the stop ring 11 in such a manner that both ends thereof locked on one side end of the operation ring 10 and one side end of the stop ring 11, respectively, and in the same manner as conventional practices, the fixing flange 9c that is formed on the front end of the adjusting screw pipe 9 is fixed between the inner and outer walls of a generally ‘[’-shaped fixing frame 6.

As the lever 4 rotates, the spindle 3 rotates together with the lever 4 to thereby make the operation ring 10 and the stop ring 11 simultaneously rotate. At this time, the torsion spring 12 is compressed in the circumferential direction thereof, so that immediately after a user's hand is separated from the lever 4, the lever 4 is returned to its original position by the recovering force of the torsion spring 12.

That is to say, the improvement of the adjusting screw pipe 9 and the housings 16 and 17 and the insertion of the annular rings 20 and 20′ which are formed between the covers 5 and 5′ and the levers 4 and 4′ enable the assembling processes to be simplified and further allow the productivity to be greatly increased, without giving any influence on its inherent operation.

As clearly understood from the foregoing, a lever door lock device according to the present invention is provided with improved principal assembling structures, thereby ensuring high assembling performance and durability.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A lever door lock device that has an outside part including a first lever, a key cylinder block, a first cover, and a first spindle, which are disposed at one side of a retractor, and an inside part including a second lever, a second cover and a locking unit, which are disposed at the other side of the retractor, the lever door lock device comprising:
an outside part lever having a first key cylinder adapted to receive the first spindle having a cut groove formed thereon and the first key cylinder block located on the rear end of the first spindle with the first key cylinder block being fitted into the first spindle, for opening and closing a door upon the operation of the outside part lever;
an adjusting screw pipe coupled to one end of the first spindle and simultaneously to the first cover;
an outside part operation unit having a first operation ring, a first stop ring, a first torsion spring, a small spindle, a fixing frame and an outer spindle support, which are coupled to one another between the outside part and the retractor, for transmitting the operational force of the outside part lever to the retractor;
an inside part lever having a second key cylinder adapted to receive a second spindle having a cut groove formed thereon and the locking unit located on the rear end of the second spindle with the locking unit being fitted into the second spindle, for opening and closing the door upon the operation of the inside part lever; and
an inside part operation unit for coupling an inner spindle, a large housing, a second stop ring, a second torsion spring, a second operation ring and a small spindle, which are coupled to one another between the outside part and the retractor, for transmitting the operational force of the inside part lever to the retractor.

2. The lever door lock device according to claim 1, wherein said adjusting screw pipe is provided with a metal piece that is fitted into the cut part formed at one side thereof.

3. The lever door lock device according to claim 1, wherein said small housing is provided with a metal piece that is fitted into the cut part formed at one side thereof.

4. The lever door lock device according to claim 1, further comprising an annular ring having a generally ‘ [symbol] ’-shaped section and disposed at the portion where said lever and said cover come in contact with each other.
